(19) United States
(12) Patent Application Publication
(10) Pub. No.: US 2006/0124888 A1
(43) Pub. Date: Jun. 15, 2006

(54) Method for treating photoactive semiconductors for improved stability and resistance to dopant leaching

(76) Inventor: William Harvey Morrison JR., Wilmington, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/008,368

(22) Filed: Dec. 9, 2004

(51) Int. Cl. C04B 35/00; B32B 27/00

(52) U.S. Cl. 252/62.3 Q; 428/405

(57) ABSTRACT

The invention is directed to a method for silica-treating semiconductors, particularly photoactive semiconductors such as BaTiO3, ZnO, and ZnS. The process comprises adding a densifying agent, such as citric acid, to an aqueous slurry of the semiconductor particles; treating the aqueous slurry with a source of silica, such as a solution of sodium silicate, to form silica-treated semiconductor particles; treating the silica-treated semiconductor particles with a source of alumina, such as a solution of sodium aluminate, to form silica- and alumina-treated photoactive semiconductor particles. The treated particles of this invention can be used in high dielectric constant compositions for use in thick films and castable tape for making multilayer circuits. The treated semiconductor particles are stable in dispersions and resist dopant leaching during high temperature processing.

### FIELD OF THE INVENTION

The present invention relates to treated semiconductor compositions. More specifically, the invention relates to photoactive semiconductor particles which are treated with a source of silica and a source of alumina in the presence of citric acid.

### BACKGROUND OF THE INVENTION

In the electronics and coatings field photoactive semiconductor materials such as BaTiO₃ or ZnO can pose compatibility challenges raised by instability of the particles in the media used to formulate intermediate and final compositions comprising a dispersion of the photoactive semiconductor. BaTiO₃ and ZnO have enough solubility in aqueous environments that reactions between soluble barium or zinc species and other components can occur leading to flocculation. Interactions between these reactive surface species and other components can also occur on the surface leading to dispersion instability in both aqueous and nonaqueous systems.

Semiconductor particles used in the electronics industry are often doped with other materials to obtain desired electrical properties. Typical dopants include, without limitation, alumina, boron or arsenic. Examples of common dopants for barium titanate are Nb₂O₅, Mg, Ni, Zn, ZnO, B₂O₃, Bi₂O₃, CdO, Pb and Sr. During exposure to common high temperature processing procedures, such as firing, dopants can leach out of the semiconductor particles. It is particularly desirable to have semiconductor particles that are capable of withstanding high temperature processing conditions without dopant leaching.

U.S. Pat. No. 5,340,393 relates to a process for preparing silica coated inorganic particles. A dense amorphous silica coating is applied to water insoluble inorganic core particles using a dispersion aid. Described dispersion aids are ammonium and alkali metal salts or acids of multicharged anions such as phosphate, pyrophosphate and citrate which are said to prevent agglomeration when adsorbed on the surface of the core particles by conferring a charge on the particles. Inorganic particles which are described are oxides of titanium, magnesium, calcium, barium, strontium, zinc, tin, nickel and iron.

### BRIEF SUMMARY OF THE INVENTION

The instant invention is directed to a process for treating photoactive semiconductor particles with silica and alumina for improved stability in aqueous and nonaqueous dispersions, comprising:
(a) forming a slurry of photoactive semiconductor particles;
(b) contacting the slurry of photoactive semiconductor particles with a densifying agent;
(c) treating the slurry of step (b) with a silica source under conditions sufficient to deposit silica onto the particles;
(d) treating the slurry of step (c) with an alumina source under conditions sufficient to deposit alumina onto the particles; and
(e) recovering the particles formed in step (d) to form photoactive semiconductor particles which have improved stability in aqueous and nonaqueous dispersions.

The process of the instant invention has been found to produce photoactive semiconductor particles of reduced solubility in aqueous and nonaqueous systems.

In one embodiment, the invention is directed to a dielectric composition comprising a dispersion of the stabilized particles in a polymeric matrix.

Semiconductor particles treated in accordance with this invention will be stable in aqueous and nonaqueous dispersions and resistant to dopant leaching during high temperature processing.

### DETAILED DESCRIPTION OF THE INVENTION

The present invention provides semiconductor particles which are surface treated with amorphous silica and amorphous alumina in the presence of a densifying agent. More specifically, the particles are coated sequentially in a wet treatment process with amorphous silica and amorphous alumina in the presence of a densifying agent.

Nonlimiting examples of suitable semiconductor particles include barium titanate (BaTiO₃), strontium titanate (SrTiO₃), zinc oxide (ZnO), zinc sulfide (ZnS), aluminosilicate, germanium oxides, silicon carbide (SiC), selenium dioxide (SeO₂), tungsten trioxide (WO3), ruthenium dioxide (RuO₂), tin dioxide (SnO₂), tantalum oxide (Ta₂O₅), calcium titanate (CaTiO₃), iron (III) oxide (Fe₂O₃), silver oxide, gallium arsenide (GaAs), molybdenum disulfide (MoS₂), indium phosphide (InP), cadmium telluride (CdTe), cadmium selenide (CdSe), gallium phosphide (GaP).

Additional representative examples of suitable semiconductor particles include iridium dioxide (IrO₂), molybdenum trioxide (MoO₃), niobium pentoxide (NbO₅), indium trioxide (In₂0₃), cadmium oxide (CdO), hafnium oxide (HfO₂), zirconium oxide (ZrO₂), manganese dioxide (MnO₂), copper oxide (Cu₂0), vanadium pentoxide (V₂O), chromium trioxide (CrO₃), yttrium trioxide (YO₃), silver oxide (AgO₂), or TiₓZr₁₋ₓO₂ wherein x is between 0 and 1; metal sulfides such as cadmium sulfide (CdS), zinc sulfide (ZnS), indium sulfide (In₂S₃), copper sulfide (Cu₂S), tungsten disulfide (WS₂), bismuth trisulfide (BiS₃), or zinc cadmium disulfide (ZnCdS₂), metal chalogenites such as zinc selenide (ZnSe), indium selenide (In₂Se₃), tungsten selenide (WSe₃); additional metal phosphides; additional metal arsenides; nonmetallic semiconductors such as silicon (Si), silicon carbide (SiC), diamond, germanium (Ge), germanium dioxide (GeO₂) and germanium telluride (GeTe); photoactive homopolyanions such as W₁₀O₃₂⁻⁴; photoactive heteropolyions such as XM₁₂O₄₀⁻ⁿ or X₂M₁₈O₆₂⁻⁷ wherein X is Bi, Si, Ge, P or As, M is Mo or W, and n is an integer from 1 to 12; and polymeric semiconductors such as polyacetylene.

Semiconductors capable of being treated in accordance with the invention are commercially available in a wide range of particle sizes from nanoparticles to granules.

Semiconductors capable of being treated in accordance with this invention are photoactive because they absorb ultraviolet light. The treatment of this invention is not believed to prevent the UV absorbing properties of the semiconductor.

Semiconductors capable of being treated in accordance with the invention are also slightly soluble in water. By slightly soluble it is meant that the semiconductors are soluble in water to a degree of less than about 2000 ppm, typically less than about 1000 ppm.

In a typical process of this invention, a slurry of photoactive semiconductor particles is heated and densifying agent is added to the slurry. The slurry is an aqueous mixture of the semiconductor particles. The slurry is then pH adjusted to form a basic composition and then treated with a source of silica, typically sodium silicate. The pH is decreased to a more neutral level by addition of acid, after which the slurry is treated with a source of alumina, typically sodium aluminate. After treatment with the source of silica and alumina the slurry is held at a certain pH and elevated temperature for a period of time sufficient to cure the particles. An objective of the curing step is to deposit silica and alumina onto the particles, more specifically, by at least partially coating the particles with a layer of silica and a layer of alumina.

The silica treatment occurs in the presence of a densifying agent and is usually carried out in aqueous solution. The densifying agent is important for densifying the coatings of silica and the alumina. Suitable densifying agents include citric acid and source of sulfate ion, such as sodium sulfate. Citric acid is the preferred densifying agent because of its dispersion enhancing properties. Other densifying agents can be a source of phosphate ion such as phosphoric acid. A useful amount of densifying agent is an amount sufficient to adequately densify the silica and alumina coatings. An excess of densification agent will maximize densification of the silica and alumina coatings but may lead to waste of the densifying agent. Suitable amounts of the densifying agent can be in the range of about 0.5% to about 3.0%, more typically from about 0.8% to about 2.4% based on weight of untreated particles.

The concentration of photoactive semiconductor particles in the slurry can range from about 50g/l to about 500 g/l more typically from about 125 to 250 grams per liter, although lower levels are also possible. Good coating consistency has been found with a relatively low concentration slurry. The temperature of the slurry usually ranges from about 45 to about 100° C. optimally from about 85 to about 100° C., although lower or higher temperatures might also be effective.

Before the above-described silica treatment, the slurry is maintained in the alkaline range, typically the pH is above about 8.5, more typically 9.0 or higher although this may depend on the equipment used (lower pH may be possible for continuous wet treatment). Sodium hydroxide can be added for purposes of maintaining the appropriate pH.

The optimal silica deposition weight is typically between about 2 and about 20, more typically from about 5 to about 18% as SiO₂ based on weight of untreated semiconductor particles. However, improvements are likely to be seen at any silica level.

Any strong mineral acid, including HCI, HNO₃ and H₂SO₄ may be used to neutralize the slurry during treatment. The optimal acid addition time for batch process ranges from 0.5 to about 4 minutes per 1% Al₂O₃ and SiO₂ added (up to 30 minutes per 1% Al₂O₃ and SiO₂ for large plant scale batches). Longer times can lead to better product at the expense of rate.

The silica treated slurry is held for a period of time preferably sufficient to deposit a coating of silica on the particles. The holding time is typically 5 minutes per 1% silica (up to 30 minutes per 1% silica for large plant batches). Shorter times can be used but the coating may not be as effective, determined by the continuousness of the coating. This holding step is typically carried out while maintaining a neutral to alkaline pH and elevated temperature. Thus, the pH usually is maintained at 7.0+1.0 and higher, typically up to and including about 10. The temperature is usually maintained above about 80° C., typically above about 90° C., more typically at about 95 to about 100° C.

In the alumina treatment the initial temperature of the slurry is optimally greater than about 80° C., typically above about 90° C., more typically in the range of about 95° to about 100° C., although lower temperatures might also be effective (or even more effective but at the expense of energy and time necessary to chill the slurry). Aluminate amount is optimally in the range of between about 5 and about 15% as Al₂O₃ based on weight of untreated particles.

Any strong mineral acid can be employed during the alumina treatment including HCl, HNO₃, and H₂SO₄. The optimal acid addition time for batch process ranges from 0.5 to about 2.0 minutes per 1% Al₂O₃ added (up to 30 minutes per 1% alumina for large plant batches). Longer times can lead to better product at the expense of rate.

After adding the alumina, the pH of the slurry is typically held at a neutral level. Optimally at 7+0.5. Higher values might lead to undesired alumina phase; lower values to incomplete deposition.

The alumina treated slurry is held for a period of time preferably sufficient to deposit a coating of alumina on the particles, typically to which a silica coating has been deposited. The holding time is typically 3 minutes per 1% alumina (upto 20 minutes per 1% alumina and silica for large plant batches). Shorter times can be used but the coating may not be as effective. This holding step is typically carried out while maintaining a neutral pH and elevated temperature. Thus the slurry usually is maintained at a slightly acidic to neutral pH, typically above about 6 to about 7.5, typically about 7.0+0.5. A temperature of at least about 40° C. is maintained, typically above about 45° C., more typically about 50° C., more typically between about 55 to about 60° C.

Particulate compositions of the present invention generally include from about 2 to about 20, generally from about 5 to about 18% amorphous silica based on the weight of the untreated particles and from about 3 to about 20%, more typically from about 5 to about 15% amorphous alumina based on the weight of the untreated particles.

The treated photoactive semiconductor particles, usually, are then filtered, washed and dried. The final particles can vary greatly in size range but typically range in average diameter from about 0.5 um to about 10 um, typically from about 1 um to about 5 um.

The photoactive semiconductor starting material can be substantially pure or it may contain other inorganic material including without limitation an inorganic coating.

Nonlimiting examples of other inorganic materials include one or more of silica, alumina, zirconia and magnesia which can be incorporated into the particle using techniques known by those skilled in the art, for example the metal oxides can be incorporated when the particles are formed or they can be added later. It will be understood that the addition of various dopants and modifiers to semiconductor particles is well known in the art. Typical dopants include Pb, Nb, P, rare earths and transition metals, and Mg, Ca, Sr, B, etc. Dopants are employed for various purposes including for controlling grain growth (such as Nb₂O₅), reducing loss (such as Mg, Ni, and Zn), densification (such as ZnO, B₂0₃, Bi₂O₃, and CdO), and shifting the Curie temperature,(Pb and Sr).

If other inorganic materials are present, they can be present in an amount of about 0.1 to about 5% based on the total semiconductor weight. It is often the case that the barium titanate starting material is composited with glass.

Inorganic coatings for the particles can include but are not limited to the oxides and hydrous oxides of silicon, aluminum, zirconium, phosphorous, zinc, rare earth elements, and mixtures of same, at loadings of 0.25 to 50 wt %, 1.0 to 25 wt per cent, and, most particularly, 2.0 to 20 wt per cent. These coatings may be used in isolation or, most preferably, in combination with one or more organic coating agents.

The semiconductor particles may have one or more such metal oxide coatings applied using techniques known by those skilled in the art prior to treatment in accordance with this invention. In one embodiment of the invention, a slurry of substantially pure semiconductor particles is “pretreated” with a source of alumina prior to contacting the slurry with citric acid. The pretreatment is typically to an amount of about 1 to about 4% based on the total semiconductor weight.

Typically, for alumina pretreated semiconductor particles, the final alumina level of products made by the invention is about 2.5% higher.

The semiconductor particles can also have an organic coating which may be applied using techniques known by those skilled in the art. A wide variety of organic coatings are known.

Organic coating agents can include but are not limited to carboxylic acids such as adipic acid, terephthalic acid, lauric acid, myristic acid, palmitic acid, stearic acid, oleic acid, salicylic acid, malic acid, maleic acid, and esters, fatty acid esters, fatty alcohols, such as stearyl alcohol, or salts thereof, polyols such as trimethylpropane diol or trimethyl pentane diol; acrylic monomers, oligomers and polymers. In addition, silicon-containing compounds are also of utility. Examples of silicon-containing compounds include but are not limited to a silicate or organic silane or siloxane including silicate, organoalkoxysilane, aminosilane, epoxysilane, and mercaptosilane such as hexyltrimethoxysilane, octyltriethoxysilane, nonyltriethoxysilane, decyltriethoxysilane, dodecyltriethoxysilane, tridecyltriethoxysilane, tetradecyltriethoxysilane, pentadecyltriethoxysilane, hexadecyltriethoxysilane, heptadecyltriethoxysilane, octadecyltriethoxysilane, N-(2-aminoethyl) 3-aminopropylmethyl dimethoxysilane, N-(2-aminoethyl) 3-aminopropyl trimethoxysilane, 3-aminopropyl triethoxysilane, 3-glycidoxypropyl trimethoxysilane, 3-glycidoxypropyl methyldimethoxysilane, 3-mercaptopropyl trimethoxysilane and combinations of two or more thereof. Polydimethylsiloxane and reactive silicones such as methylhydroxysiloxane may also be useful.

The particles may also be coated with a silane having the formula:
RₓSi(R′)₄−x
wherein
R is a nonhydrolyzable aliphatic, cycloaliphatic or aromatic group having at least 1 to about 20 carbon atoms;
R′is a hydrolyzable group such as an alkoxy, halogen, acetoxy or hydroxy or mixtures thereof; and
x=1 to3. For example, silanes useful in carrying out the invention include hexyltrimethoxysilane, octyltriethoxysilane, nonyltriethoxysilane, decyltriethoxysilane, dodecyltriethoxysilane, tridecyltriethoxysilane, tetradecyltriethoxysilane, pentadecyltriethoxysilane, hexadecyltriethoxysilane, heptadecyltriethoxysilane and octadecyltriethoxysilane. Additional examples of silanes include, R=8-18 carbon atoms; R′=chloro, methoxy, hydroxy or mixtures thereof; and x=1 to 3. Preferred silanes are R=8-18 carbon atoms; R′=ethoxy; and x=1 to 3. Mixtures of silanes are contemplated equivalents. The weight content of the treating agent, based on total treated particles can range from about 0.1 to about 10 wt. %, additionally about 0.7 to about 7.0 wt. % and additionally from about 0.5 to about 5 wt %.

Photoactive semiconductor particles, treated according to the present invention, may be used with advantage in various applications including; coatings formulations including automotive coatings, wood coatings, and surface coatings; chemical mechanical planarization products; catalyst products; photovoltaic cells; plastic parts, films, and resin systems including agricultural films, food packaging films, molded automotive plastic parts, and engineering polymer resins; rubber based products including silicone rubbers; textile fibers, woven and nonwoven applications including polyamide, polyaramid, and polyimide fiber products and nonwoven sheet products; ceramics; glass products including architectural glass, automotive safety glass, and industrial glass; electronic components; and other uses in which photoactive semiconductors will be useful.

One particular utility for the particles of this invention is in dielectric composites of the kind described in U.S. Pat. No. 6,600,645 for forming capacitors, filters and the like. Thus, in one embodiment, the invention is directed to a dielectric medium comprising a polymeric matrix having the particles of the instant invention dispersed therein. In another embodiment, the invention is directed to an electrical capacitor comprising a dielectric medium disposed between two conductive electrodes wherein the dielectric medium comprises a polymeric matrix having the particles of the instant invention dispersed therein. In still another embodiment, the invention is directed to a prefired ceramic dielectric for polymer thick-film capacitors comprising a polymer matrix having the particles of the instant invention dispersed therein. The invention is yet further directed to a method for making a dielectric composite material comprising the steps of treating photoactive semiconductor particles in accordance with the instant invention then dispersing the particles in a polymer matrix to form a planar dielectric composite material and applying electrodes to opposite surfaces of the dielectric composite material.

Capacitor materials containing a dielectric medium comprising the semiconductor particles of this invention can be used for high dielectric constant products (k>15, additionally higher than about 30). The process of this invention for treating photoactive semiconductors can be used to inhibit a negative interaction between the glass of the thick-film compositions and the capacitor material which can lower the dielectric constant. While the silica of the coating can lower the dielectric constant, it would not lower the dielectric constant as much as the negative interaction between the glass and the capacitor material.

The dielectric composite material can be used in thick film compositions and castable tape compositions for fabrication of multilayer circuits.

Castable tape compositions, typically flexible polymer tapes, can be made by well known tape-casting techniques and diced or slit into convenient sizes. The electrodes may be applied to this tape either before or after dicing. Alternatively, if a large capacitance is needed, a long length of the dielectric tape material can be electroded and then rolled into a cylindrical geometry with an interlayer of insulating paper or the like to prevent contact of the two electrodes. The matrix may also be formulated as a printable dielectric with or without the electrodes wherein the matrix is formulated as a printable vehicle containing polymer and solvent. The dielectric composite and/or electrodes may be printed onto a substrate to form, for example, a capacitor. Thick film compositions can be applied by screen-printing. The general principles of printable thick-film formulations are well known in the art and many suitable polymer/solvent combinations are available. The particular combination chosen for a specific situation will depend upon the substrate material, feature size to be printed and other relevant factors well understood by those skilled in the art.

An organic medium used in making thick-film compositions serves as a vehicle for dispersion of the finely divided particles of the composition in such form that it can readily be applied to ceramic or other substrates. Thus the organic medium must be one in which the particles will be dispersible with an adequate degree of stability. The particles of this invention are particularly suitable for use with a wide variety of organic media because of the citric acid treatment which enhances compatibility with a variety of organic media. The rheological properties of the organic medium is important for materials handling. The viscosity properties of the thick film composition must be appropriate for screen printing techniques. The organic medium for most thick film compositions is typically a solution of resin in a solvent frequently also containing thixotropic agents and wetting agents. The solvents usually boil within the range of about 130 to about 350° C. Suitable solvents include kerosene, mineral spirits, dibutylphthalate, butyl carbitol, butyl carbitol acetate, hexylene glycol and high boiling alcohols, alcohol esters and terpineol. Various combinations of these and other solvents can be formulated to obtain the desired viscosity and volatility.

A typical resin for a thick film composition is ethyl cellulose. However, resins such as ethylhydroxycellulose, wood rosin, mixtures of ethyl cellulose and phenolic resins, polymethacrylates or lower alcohols and monobutyl ether of ethylene glycol monoacetate and polyalpha methylstyrene can also be used. The invention may also lend itself to water-based systems. Resins suitable for water based systems include, without limitation, polyvinylpyrrolidone, copolymers with polyvinyl alcohol, hydroxyethylcellulose, methylcellulose, hydroxypropylcellulose, sodium carboxymethylcellulose, polyvinylacetate and neutralized acrylic polymers. Suitable co-solvents suitable for water-based systems are butyl cellosolve, tetraethylene glycol, butyl carbitol, butyl carbitol acetate, ethylene glycol, glycerol, ethylene glycol diacetate, carbitol acetate, n-methyl-pyrolidone, hexylene glycol, dipropyleneglycol monomethyl ether, 1-methoxy-2-propanol acetate, propylene glycol phenyl ether, and dipropylene glycol phenyl ether.

Among the thixotropic agents which are commonly used is hydrogenated castor oil and derivatives thereof and ethyl cellulose. It is not always necessary to incorporate a thixotropic agent since the solvent and resin properties coupled with the shear thinning inherent in the dispersion may be suitable.

Suitable wetting agents include, without limitation, phosphate esters and soya lecithin.

The ratio of organic medium to solids in the dispersion can vary considerably and depends upon the manner in which the dispersion is to be applied and the kind of organic medium used; i.e., determined mainly by the final desired formulation viscosity and print thickness. Normally to achieve good coverage, the dispersions will contain complementary by weight about 40 to about 90% solids and about 60 to about 10% organic medium.

The particles of this invention may also be formulated as a paint-like material for coating selected surfaces to modify their dielectric properties. For these applications, conventional water-based or solvent-based paint vehicles may be used. Alternatively, a more durable coating may be formulated by dispersing the particles of this invention in a thermosetting system such as epoxy or the like and curing the coating after application. It will be understood that the conformal coating described here may be applied as a single layer or as a plurality of layers, whereby the dielectric properties of the coating may be graded. Successive layers might contain different compositions. The conformal coatings may contain other functional or inert components such as plasticizers, colorants, light absorbent pigments that are well known in the art.

One area of increasing demand for particles which will absorb UV light, especially, zinc oxide is in sunscreen and cosmetic formulations, particularly in sunscreens as a sunscreen agent. Zinc oxide nanoparticles, such as Z-Cote® transparent zinc oxide marketed by Applied Therapeutics are said to provide protection from the ultraviolet rays of the sun (UV A and UV B radiation).

A dispersant is usually required to effectively disperse the particles in a fluid medium. Careful selection of dispersants is important. Typical dispersants that can be used with the particles of this invention include aliphatic alcohols, saturated fatty acids and fatty acid amines.

When the particles of this invention are incorporated into a sunscreen formulation the amount of the particles can be up to and including about 25 wt.%, typically from about 0.1 wt.% to up to 15 wt. %, even more preferably unto 6 wt.%, based on the weight of the formulation, the amount depending upon the desired sun protection factor (SPF) of the formulation. The sunscreen formulations are usually an emulsion and the oil phase of the emulsion typically contains the UV active ingredients such as the titanium dioxide particles of this invention. Sunscreen formulations typically contain in addition to water, emollients, humectants, thickeners, UV actives, chelating agents, emulsifiers, suspending agents (typically if using particulate UV actives), waterproofers, film forming agents and preservatives.

Specific examples of preservatives include parabens. Specific examples of emollients include octyl palmitate, cetearyl alcohol, and dimethicone. Specific examples of humectants include propylene glycol, glycerin, and butylene glycol. Specific examples of thickeners include xanthan gum, magnesium aluminum silicate, cellulose gum, and hydrogenated castor oil. Specific examples of chelating agents include disodium ethylene diaminetetraacetic acid (EDTA) and tetrasodium EDTA. Specific examples of UV actives include ethylhexyl methoxycinnamate, octocrylene, and titanium dioxide. Specific examples of emulsifiers include glyceryl stearate, polyethyleneglycol-100 stearate, and ceteareth-20. Specific examples of suspending agents include diethanolamine-oleth-3-phosphate and neopentyl glycol dioctanoate. Specific examples of waterproofers include C30-38 olefin/isopropyl maleate/MA copolymer. Specific examples of film forming agents include hydroxyethyl cellulose and sodium carbomer. Numerous means are available for preparing dispersions of titanium dioxide nanoparticles containing dispersants. Intense mixing, such as milling and grinding may be needed, for example, to break down agglomerates into smaller particles. To facilitate use by the customer, producers of the particles may prepare and provide dispersions of the particles in a fluid medium which are easier to incorporate into formulations.

In another embodiment, the invention is directed to a coating composition comprising an additive amount of the photoactive semiconductor particles of this invention in a protective coating formulation.

Many cars are now coated with a clear layer of polymer coating to protect the underlying color coat, and ultimately the metal body parts. This layer can include photoactive semiconductor particles of this invention. The clear coat layers are normally solvent based, but can also be water based. Such coatings are well known in the art.

Photoactive semiconductor particles of this invention can also be used in polymer composites.

Polymers which can be suitable for use in the present invention include, by way of example but not limited thereto, polymers of ethylenically unsaturated monomers including olefins such as polyethylene, polypropylene, polybutylene, and copolymers of ethylene with higher olefins such as alpha olefins containing 4 to 10 carbon atoms or vinyl acetate, and the like.; vinyls such as polyvinyl chloride, polyvinyl esters such as polyvinyl acetate, polystyrene, acrylic homopolymers and copolymers; phenolics; alkyds; amino resins; epoxy resins, polyamides, polyurethanes; phenoxy resins, polysulfones; polycarbonates; polyether and chlorinated polyesters; polyethers; acetal resins; polyimides; and polyoxyethylenes. The polymers according to the present invention also include various rubbers and/or elastomers either natural or synthetic polymers based on copolymerization, grafting, or physical blending of various diene monomers with the above-mentioned polymers, all as generally known in the art. Thus generally, the present invention is useful for clear or pigmented plastic or elastomeric compositions. For example, but not by way of limitation, the invention can be useful for polyolefins such as polyethylene, polypropylene, polyvinyl chloride, polyamides and polyester.

### TEST METHODS

Isoelectric Point

To 225 grams of 0.001 N KNO3 solution was added the desired amount (usually 4 wt%) of dry powder sample. This dispersion was sonicated for about 15 seconds and the resultant dispersion was gently stirred for about 15 minutes. About 210 g of this dispersion was placed into the measuring beaker on the AcoustoSizer from Colloid Dynamics and the standard measurement cycle was run in accordance with the prescribed operating procedure provided by the computer software. This program allowed for automatic pH adjustments so that the zeta potential could be determined as a function of pH. The point at zero zeta potential was the IEP.

Treatment of the semiconductor particles in accordance with this invention reduced the isoelectric point (IEP) showing that the particles were coated.

The results of these tests were reported below for each of the examples.

### EXAMPLES

### Example 1

The following ingredients were placed in a plastic bottle in order: 50.00 g zinc oxide (Z-Cote®, a microfine transparent zinc oxide marketed by Applied Therapeutics) and 400 ml total volume deionized polished water. The ingredients were stirred and sonicated for 10 minutes at a power of 7 and screened through a 325 mesh sieve. The screened mixture was added to a stainless steel beaker equipped with an air motor stirrer, temperature probe, and pH probe. The mixture was rapidly agitated using a propeller blade.

The initial pH was 6.7. The mixture was heated to 60° C. and the pH was adjusted to 6-8 with 50% NaOH solution (Og/pH=6.40). Then 4.5 g sodium aluminate giving a pH of 11.28 (400g/l alumina, 27.8 wt%, 1.44 g/ml) was added. The mixture was stirred for 15 minutes. The mixture was heated to above 90° C. The pH was 10.3. Then 0.80 g of 50% citric acid solution was added. The pH after citric acid addition was 9.30. The pH was adjusted to 10.5-11.0 with 50% NaOH solution (1.98 g). The pH was 10.74. Then 10.75 g sodium silicate (27 wt% silica, ˜360 g/l silica, 1.34 g/ml) was added with strong stirring. Over about 15 minutes concentrated (38%) hydrochloric acid solution was added to reduce the pH to 7 (7.43 g HCl). The mixture was stirred for 45 minutes at above 90° C. The heat was stopped and the pH was reduced to the range of 6-8 with concentrated (38%) HCl (5.0 g) while adding 9.0 g sodium aluminate drop-wise over 6 minutes. The mixture was stirred for 20 minutes while maintaining a pH of 7. At the end of 20 minutes the temperature was 47° C. The pH was 7.07. The pH was adjusted to 6.0+/−0.3 with 0.97 g concentrated (38%) HCl. The mixture was stirred again for 5 minutes. The final mixture was filtered, washed with deionized polished water to <143 mhos/cm conductance (˜2.25 liters water, 111 micro mhos/cm). The mixture was vacuum dried for about 30 minutes to form a cake then ethanol was added to cover the cake for about 15 minutes. The cake was then vacuum dried again for about 30 minutes. The cake was dried in a vacuum oven at 125° C. on an aluminum tray overnight. The dry material was ground and sieved through a 35 mesh screen and dried again. The yield was 54 g.

Measured SiO₂: 4.79%

Measured Al₂O₃: 6.45%

The isoelectric point of the ZnO treated in accordance with the procedure of this example and the isoelctric point of the untreated ZnO is reported in Table 1 below.

### Example 2

The following ingredients were placed in a plastic bottle in order: 90.00 g barium titanate and 720 ml total volume deionized polished water. The ingredients were stirred and sonicated for 10 minutes at a power of 7 and screened through a 325 mesh sieve. The screened mixture was added to a stainless steel beaker equipped with an air motor stirrer, temperature probe, and pH probe. The mixture was rapidly agitated using a propeller blade.

The initial pH was 8.4. The mixture was heated to 60° C. and the pH was adjusted to 6-8 with 50% NaOH solution (0.25 g/pH=7.27). Then 8.1 g sodium aluminate giving a pH of 11.41 (400g/l alumina, 27.8 wt%, 1.44 g/ml) was added. The mixture was stirred for 15 minutes. The mixture was heated to above 90° C. The pH was 10.3. Then 1.44 g of 50% citric acid solution was added. The pH after citric acid addition was 9.57. The pH was adjusted to 10.5-11.0 with 50% NaOH solution (2.52 g). The pH was 10.67. Then 19.35 g sodium silicate (27 wt% silica, ˜360 g/l silica, 1.34 g/ml) was added with strong stirring giving a pH of 11.02. Over about 15 minutes concentrated (38%) hydrochloric acid solution was added to reduce the pH to 7 (11.74 g HCl). The mixture was stirred for 45 minutes at above 90° C. The heat was stopped and the pH was reduced to the range of 6-8 with concentrated (38% HCl) (12.49 g) while adding 16.2 g sodium aluminate drop-wise over 7 minutes. The mixture was stirred for 20 minutes while maintaining a pH of 7. At the end of 20 minutes the temperature was 41° C. The pH was 6.72. The pH was adjusted to 6.0+/−0.3 with 0.25 g concentrated (38%) HCl. The mixture was stirred again for 5 minutes. The final mixture was filtered, washed with deionized polished water to <143 mhos/cm conductance (˜8 liters water, 31.6 micro mhos/cm). The mixture was vacuum dried for about 30 minutes to form a cake then ethanol was added to cover the cake for about 15 minutes. The cake was then vacuum dried again for about 30 minutes. The cake was dried in a vacuum oven at 125° C. on an aluminum tray overnight. The dry material was ground and sieved through a 35 mesh screen and dried again. The yield was 98 g.

Measured SiO₂: 7.94%

Measured Al₂O₃: 5.35%

The isoelectric point of the BaTiO₃ treated in accordance with the procedure of this example and the isoelectric point of the untreated BaTiO3 is reported in Table 1 below.

TABLE 1

| Example | % SiO₂ | % Al₂O₃ | iep |
|---|---|---|---|
| ZnO | 0 | 0 | 9.8 |
| Example 1 | 4.70 | 6.45 | 8.7 |
| BaTiO₃ | 0 | 0 | >8 |
| Example 2 | 5.35 | 7.94 | 6.3 |

The IEP of the photoactive semiconductor was reduced by the treatment process of this invention indicating that the surface of the semiconductor was at least partially if not completely coated with silica and alumina.

The description of illustrative and preferred embodiments of the present invention is not intended to limit the scope of the invention. Various modifications, alternative constructions and equivalents may be employed without departing from the true spirit and scope of the appended claims.

What is claimed is:

1. A process for treating photoactive semiconductor particles with silica and alumina for improved stability in aqueous and nonaqueous dispersions, comprising:
(a) forming a slurry of photoactive semiconductor particles;
(b) contacting the slurry of photoactive semiconductor particles with a densifying agent;
(c) treating the slurry of step (b) with a silica source under conditions sufficient to deposit silica onto the particles;
(d) treating the slurry of step (c) with an alumina source under conditions sufficient to deposit alumina onto the particles; and
(e) recovering the particles formed in step (d) to form photoactive semiconductor particles for improved stability in aqueous and nonaqueous dispersions.

2. The process of claim 1 further comprising contacting the photoactive semiconductor particles with sodium aluminate prior to contacting the slurry with densifying agent.

3. The process of claim 1 in which the slurry is treated with sodium silicate.

4. The process of claim 1 in which the slurry is treated with sodium aluminate.

5. The process of claim 1 in which the densifying agent is added to the slurry to a concentration based on the weight of the photoactive semiconductor particles of from about 0.1 to about 3%.

6. The process of claim 1 further comprising contacting the treated particles with an organic composition.

7. The process of claim 6 in which the organic composition comprises at least one of octyltriethoxysilane, aminopropyltriethoxysilane, polyhydroxystearic acid, and polyhydroxy siloxide.

8. The process of claim 1 in which the densifying agent is citric acid.

9. The process of claim 1 in which the densifying agent is a source of phosphate ion or a source of sulfate ion.

10. The process of claim 1 in which the conditions of step (c) are sufficient to deposit the silica onto the particles in an amount ranging from about 5 weight percent to about 18 weight percent based on the weight of the particles in the mixture.

11. The process of claim 1 in which the conditions of step (d) are sufficient to deposit the alumina in an amount ranging from about 5 weight percent to about 15 weight percent based on the weight of the particles.

12. The process of claim 1 in which the photoactive semiconductor are selected from the group consisting of barium titanate (BaTiO₃), strontium titanate (SrTiO₃), zinc oxide (ZnO), zinc sulfide (ZnS), aluminosilicate, germanium oxides, silicon carbide (SiC), selenium dioxide (SeO₂), tungsten trioxide (WO3), ruthenium dioxide (RuO₂), tin dioxide (SnO₂), tantalum oxide (Ta₂O₅), calcium titanate (CaTiO₃), iron (III) oxide (Fe₂O₃), silver oxide, gallium arsenide (GaAs), molybdenum disulfide (MoS₂), indium phosphide (InP), cadmium telluride (CdTe), cadmium selenide (CdSe), and gallium phosphide (GaP).

13. A dielectric composition comprising a dispersion of the treated semiconductor of claim 1 in a polymeric matrix.

14. The process of claim 12 in which the photoactive semiconductor further comprises a dopant selected from the group consisting of one or more of silica, alumina, zirconia, phosphorus, magnesia, lead, niobium, calcium, strontium, boron, and rare earth element, the photoactive semiconductor being capable of resisting dopant leaching.

15. A composition for absorbing ultraviolet radiation comprising the photoactive semiconductor of claim 1.
